(19) United States
(12) Patent Application Publication
(10) Pub. No.: US 2026/0023460 A1
(43) Pub. Date: Jan. 22, 2026

(54) TASK PROCESSING METHOD AND APPARATUS, DEVICE AND MEDIUM

(71) Applicant: Beijing Zitiao Network Technology Co., Ltd., Haidian District, Beijing (CN)

(72) Inventors: Xinlei Guo, Beijing (CN); Qiansong Xu, Beijing (CN); Ronghui Zhang, Beijing (CN); Shijie Liu, Beijing (CN)

(21) Appl. No.: 18/858,208

(22) PCT Filed: Apr. 13, 2023
(86) PCT No.: PCT/CN2023/088002

§ 371 Date: Oct. 18, 2024

(30) Foreign Application Priority Data
Apr. 19, 2022 (CN) 202210409379.6

(51) Int. Cl. G06F 3/0484; G06F 3/0482; G06F 3/0483; G06F 9/451

(52) U.S. Cl. CPC G06F 3/0484; G06F 3/0482; G06F 3/0483; G06F 9/452

(57) ABSTRACT

Embodiments of the present disclosure relate to a method and apparatus for processing a task, device and medium. The method comprises: obtaining target information created by a first user; displaying, based on the target information, at least one of the target information in a first page view and displaying target description information corresponding to the at least one of the target information; wherein the target description information is created by a user having permission to target information. Accordingly, the relevant information of the task scatteringly reported by different users may be collectively viewed based on the related page view, which promotes the efficiency for viewing the task progress and provides technical support for task review and summary.

### CROSS REFERENCE TO RELATED APPLICATION(S)

The present application claims priority to Chinese patent application No. 202210409379.6, filed with the China Intellectual Property Administration on Apr. 19, 2022 and entitled “TASK PROCESSING METHOD AND APPARATUS, DEVICE AND MEDIUM”, the entirety of which priority application is hereby incorporated by reference herein.

### FIELD

The present disclosure relates to computer application technology field, and more specifically to task processing method and apparatus, device and medium.

### BACKGROUND

With computer technology developments, it is common for employees of enterprises to formulate and summarize work objectives with software tools.

In the related art, after formulating the work objectives, users are often required to transfer the work objectives into their own files for summary and progress update, which could not be directly completed in the work objective tools. Further, users are also required to incorporate personal summary into the summary report of the entire team. This however is rather tedious and greatly affects work efficiency.

### SUMMARY

To address or at least partly address the above technical problems, the present disclosure provides a method and apparatus for processing a task, device and medium. The relevant information of the task scatteringly reported by different users may be collectively viewed based on the related page view, which promotes the efficiency for viewing the task progress and provides technical support for task review and summary.

Embodiments of the present disclosure provide a method for processing a task, comprising: obtaining target information created by a first user; and displaying, based on the target information, at least one of the target information in a first page view and displaying target description information corresponding to the at least one of the target information; wherein the target description information is created by users having permission to target information.

Embodiments of the present disclosure also provide an apparatus for processing a task, comprising: an obtaining module for obtaining target information created by a first user; and a display module for displaying, based on the target information, at least one of the target information in a first page view and displaying target description information corresponding to the at least one of the target information; wherein the target description information is created by users having permission to target information.

Embodiments of the present disclosure also provide an electronic device, comprising: a processor; a memory for storing instructions executable by the processor; wherein the processor reads the executable instructions from the memory and performs the executable instructions to implement the method for processing a task provided by the embodiments of the present disclosure.

Embodiments of the present disclosure also provides a computer-readable storage medium stored with a computer program, the computer program performing the method for processing a task provided by the embodiments of the present disclosure.

Compared to the prior art, the technical solution according to the embodiments of the present disclosure has following merits:

The method for processing a task according to the embodiments of the present disclosure displays, in the first view, corresponding target information and target description information corresponding to the target information after a first user creates the target information, wherein the target description information is created by a user having target permission. Thus, the relevant information of the task scatteringly reported by different users may be collectively viewed based on the related page view, which promotes the efficiency for viewing the task progress and provides technical support for task review and summary.

### BRIEF DESCRIPTION OF THE DRAWINGS

Through the following detailed implementations with reference to the accompanying drawings, the above and other features, advantages and aspects of various embodiments of the present disclosure will become more apparent. Throughout the drawings, same or similar reference signs indicate same or similar elements. It is to be understood that the drawings are exemplary, in which original components and elements are not necessarily drawn to scale.

FIG. 1 illustrates an interface diagram of a first page view provided by embodiments of the present disclosure;

FIG. 2 illustrates a flowchart diagram of a method for processing a task provided by embodiments of the present disclosure;

FIG. 3 illustrates another interface diagram of a first page view provided by embodiments of the present disclosure;

FIG. 4 illustrates a further flowchart diagram of a method for processing a task provided by embodiments of the present disclosure;

FIG. 5 illustrates a further interface diagram of a first page view provided by embodiments of the present disclosure;

FIG. 6 illustrates a further interface diagram of a first page view provided by embodiments of the present disclosure;

FIG. 7 illustrates a schematic diagram of a task processing scenario provided by embodiments of the present disclosure;

FIG. 8 illustrates a further flowchart diagram of a method for processing a task provided by embodiments of the present disclosure;

FIG. 9 illustrates a further interface diagram of a first page view provided by embodiments of the present disclosure;

FIG. 10 illustrates a structural diagram of an apparatus for processing a task provided by embodiments of the present disclosure;

FIG. 11 is a structural diagram of an electronic device provided by embodiments of the present disclosure.

### DETAILED DESCRIPTION OF EMBODIMENTS

The embodiments of the present disclosure will be described in more details with reference to the drawings. Although the drawings illustrate some embodiments of the present disclosure, it should be appreciated that the present disclosure can be implemented in various manners and should not be limited to the embodiments explained herein. On the contrary, the embodiments are provided to make the present disclosure more thorough and complete. It should be appreciated that the drawings and the embodiments of the present disclosure are provided only for exemplary purpose, rather than restricting the protection scope of the present disclosure.

It is to be understood that respective steps disclosed in the method implementations of the present disclosure may be executed in different orders and/or in parallel. Besides, the method implementations may include additional steps and/or omit the demonstrated steps. The scope of the present disclosure is not restricted in this regard.

As used herein, the term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least a further embodiment.” The term “some embodiments” is to be read as “at least some embodiments”. Related definitions of other terms may be provided in the following description.

It is to be noted that “first” and “second” are disclosed in the present disclosure merely for distinguishing different apparatuses, modules or units, rather than restricting the sequence of the functions executed by the apparatuses, modules or units or the interdependence.

It is to be noted that the terms “one” and “more” disclosed in the present disclosure are exemplary rather than restrictive. Those skilled in the art should understand that the above terms are to be read as “one or more” unless indicated otherwise in the context.

Names of the messages or information exchanged between a plurality of apparatuses in the implementations of the present disclosure are provided only for explanatory purpose, rather than restricting the scope of the messages or information.

To address the above issues, embodiments of the present disclosure provide a method for processing a task, wherein the task in the embodiments of the present disclosure may be any task files involving work progress report, including but not limited to, weekly report files, daily report files and monthly report files etc.

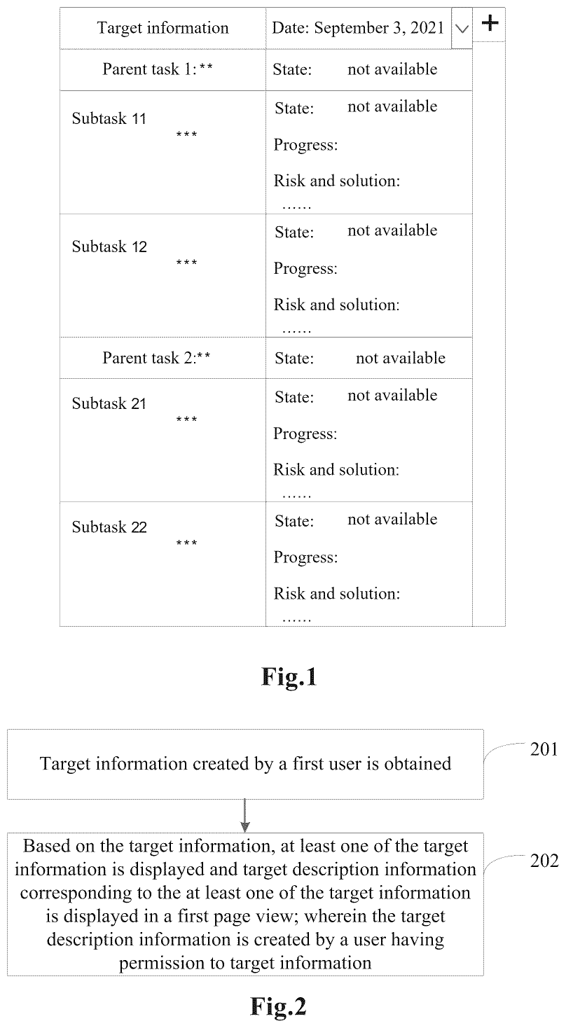

As shown in FIG. 1, a task progress file in general includes a parent task set for each phase, and the parent task for each phase is divided into subtasks. The task progress file contains description information regarding each parent task and description information about subtasks under each parent task, the description information including but not limited to state (completed or in progress, etc.), progress (work progress already made), risk evaluation and solution of the task at a corresponding point-in-time. The task progress file may give a clear picture about the task progress at each point-in-time, as well as the task progress of each parent task and subtask etc.

It is to be explained that that the task progress file, the parent task and the subtask may be displayed in form of one column of a list, or in any other forms, which will not be demonstrated here. For the sake of description, the description information of the task is displayed in the column of the list as an example for explanation throughout the embodiments of the present disclosure.

The method is to be introduced below with reference to specific embodiments.

FIG. 2 is a flowchart diagram of a method for processing a task provided by embodiments of the present disclosure. The method may be executed by an apparatus for processing a task, wherein the apparatus may be implemented by software and/or hardware and is generally integrated in an electronic device. According to FIG. 2, the method comprises:

Step 201: target information created by a first user is obtained.

The first user may be any one or more users in a work group, and also may be a user designated in charge of reporting the initial task progress file.

The target information may be interpreted as subject name of the task, wherein the subject name of the task includes, but not limited to, parent task, subtask and the like, i.e., a first piece of target information may include first target information and second target information, where the first target information may be considered as parent task information and the second target information may be regarded as subtask information etc. Since each parent task may include a plurality of subtasks, each first target information corresponds to at least one second target information and the first target information and the second target information are associated with each other in contents.

In some possible embodiments, to display the target information in a more straightforward way for the viewing user to visually acquire the task progress, the first target information may correspond to at least one of state information, the state information identifies task progress state; and the second target information may correspond to respective state information and at least one target description information, wherein the state information corresponding to the second target information describes task progress of the subtasks corresponding to the second target information and the target description information describes specific details of the respective subtasks in corresponding scenarios.

Step 202: based on the target information, at least one of the target information is displayed and target description information corresponding to the at least one of the target information is displayed in a first page view; wherein the target description information is created by a user having permission to target information.

As stated above, the target description information describes task details of the corresponding target information and includes, but not limited to, state (completed or in progress, etc.), progress (work progress already made), risk evaluation and solution of the task at a corresponding point-in-time. The target information may be created by a user having permission to target information. Accordingly, the user having permission to the target information also may add corresponding target description information to the target information in addition to viewing the target information report by the first user. The scattered target information is thus collaboratively edited. The user having permission to the target information may include a first user and also other users having edit permission, and the other users include but not limited to users designated by the first user, and upper-level users of the first user etc.

In one embodiment of the present disclosure, at least one target information is displayed in a first page view on the basis of the target information. The first view may be understood as a view page of the task progress that can be seen by each of the users with permission. In some possible embodiments, the first user may create target information in a second page view; and the second page view and the first page view may be different pages on different clients. The second page view is displayed at a client where the first user resides for receiving target information input by the first user and target information reported by all first users among the users of the first page view, to see the overall progress of the task.

In some further possible embodiments, the first page view and the second page view also may be displayed at the same client. As such, the users of the same client can create and view the target information.

The ways for acquiring the first page view and the second page view may differ depending on the application scenarios. In some possible embodiments, the first page and the second page may be follow-up pages inserted into the file page in form of web page.

In summary, the method for processing a task according to the embodiments of the present disclosure displays, in the first view, corresponding target information and target description information corresponding to the target information after the first user creates the target information, wherein the target description information is created by a user having target permission. Thus, the relevant information of the task scatteringly reported by different users may be collectively viewed based on the related page view, which promotes the efficiency for viewing the task progress and provides technical support for task review and summary.

In actual execution, to better synchronize related information of the task progress and avoid scattering the progress information (including target description information and the target information etc.) belonging to the same task in different files, the viewing user not only view the corresponding target information collaboratively but also edit the target information in the same fashion in the embodiments of the present disclosure. In other words, a plurality of viewing users may collaboratively edit the target information.

In one embodiment of the present disclosure, displaying at least one of the target information in a first page view and displaying target description information corresponding to the at least one of the target information includes: generating in the first page view a display frame including a first display area and at least one second display area, the first display area corresponding to at least one second display area and being used for displaying the target information, and the second display area being used for displaying the target description information. The first display area may display subject names of the parent task and subtasks and each first display area has a corresponding second display area on which the target description information of the corresponding task is displayed for users to visually obtain the task progress.

In this embodiment, to satisfy the collaborative editing needs, the display frame is changed in response to an area editing request from the viewing user.

In one embodiment of the present disclosure, in response to an area addition request for the display frame from the viewing user, an adding position corresponding to the area addition request is obtained; and the second display area is added at the adding position of the display frame in accordance with a preset display pattern of the second display area.

For example, in case that the viewing user perform a preset area addition operation, e.g., the viewing user trigger a corresponding area addition control, the area addition request from the viewing user is obtained. In such case, a second display area for describing the work progress is added in a page frame. Further, an adding position is determined in accordance with the position where the user performs the area addition operation, and the second display area is added at the adding position of the display frame based on a preset display pattern of the second display area.

In some possible embodiments, the display frame is a list and if the second display area is displayed in a column of the list, the second display area is added at the adding position in the form of row in accordance with preset rendering parameters and default description information; if the second display area is displayed in a row of the list, the second display area is added at the adding position in the form of column in accordance with preset rendering parameters and default description information, where the preset rendering parameters include, but not limited to, rendering size and rendering color of the area and the like, and the default description content may be corresponding target information by default.

In this embodiment, the corresponding second display area is rendered and displayed in the display frame in accordance with the rendering parameters and the default description information, where the second display area matches the corresponding first display area. The corresponding second display area is displayed for the target information in each first display area, and the corresponding default description information is displayed in the second display area. In the event that multiple users add an area, the added second display areas may be sequentially displayed on all viewing terminals by addition order.

After the added second display area is rendered, in response to a request for modifying the default description information in the second display area from the viewing user, the modified target description information is obtained and the target description information is then displayed on all viewing terminals.

In some possible embodiments, any target description information in the current frame may also be modified and edited. Here, permission of the viewing user who have already modified the released target description information may be further validated and a corresponding modification function may be opened to the viewing user having preconfigured modification permissions.

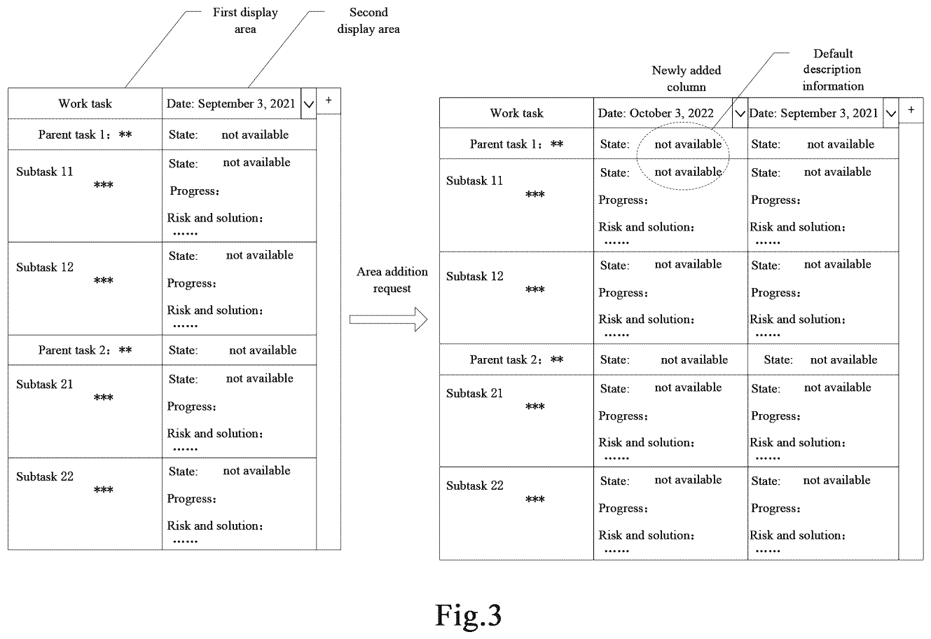

For example, as shown in FIG. 3, if an area addition request is obtained from the viewing user B, the second display area is added in the display frame in accordance with the preset rendering parameters and the default description information.

In one embodiment of the present disclosure, in response to an area deletion request for the display frame from the viewing user, a first target display area corresponding to the area deletion request is obtained; the first target display area is deleted from the display frame. The viewing user also may delete a display area from the page frame, or modify the display size of a display area in the page frame. For example, the viewing user may zoom the size of the first target display area by pulling the corresponding first target display area. Progress description area of other files automatically adjusts the display frame as a function of the size of the zoomed first target display area.

In one embodiment of the present disclosure, in response to an operation of selecting the second target display area in the display frame from the viewing user, a dragging operation on the second target display area by the viewing user is obtained, and a display position of the second target display area in the display frame is changed based on the dragging operation. For example, in response to change of the position of the second display area in a certain column by the viewing user, if a plurality of viewing users drag the same column simultaneously, the dragged positions may take effect successively.

In summary, the method for processing a task according to embodiments of the present disclosure enables the viewing user to collaboratively edit the display frame, provides technical support for collectively aligning the target description information scatted among all users, and further facilitates work review and summary.

Based on the above embodiments, to satisfy interaction needs of some users in the work group and further improve the work efficiency, the viewing user also may post comments on contents in the first page view and communicate the work based on the comments.

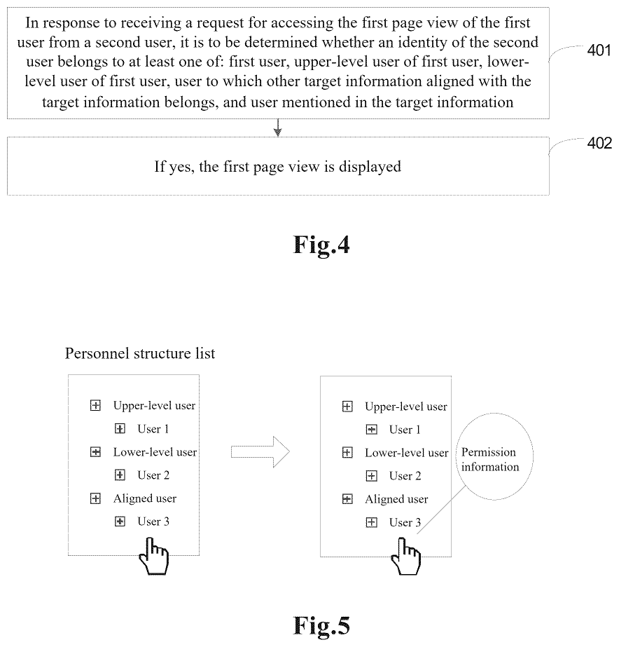

That is, in one embodiment of the present disclosure, the method according to FIG. 4 also includes:

Step 401: in response to receiving a request for accessing the first page view of the first user from a second user, it is to be determined whether an identity of the second user belongs to at least one of: the first user, an upper-level user of first user, a lower-level user of first user, a user to which other target information aligned with the target information belongs, and a user mentioned in the target information;

Step 402: if yes, the first page view is displayed.

In this embodiment, the viewing user having view permission may view the first page view containing the target information created by the first user.

A second user having view permission may be determined in accordance with the level information of the first user. In other words, the second user having permission to the target information may be determined based on the level information of the first user in a corresponding task group.

In one embodiment of the present disclosure, the target information created by the first user is not only viewable by the first user himself. To allow other users to view the target information, the second user having view permission is determined.

In the embodiment, the level information of the first user is determined and the level information may be preconfigured level information of the first user in the task group. Position information of the first user in the task group may also be obtained. The level information of the first user is determined based on the position information and the second user having view permission may be determined on the basis of the level information of the first user.

To flexibly meet the scenario requirements, the user information may also be associated in the target information, and the associated user information is determined as the second user. The associated user information is the user information mentioned in the target information contained in the first page view. For instance, the target information contains a preset association identifier, and the user information corresponding to the association identifier is obtained as the associated user information, wherein the association identifier may be any preconfigured identifier, e.g., symbol “@”.

That is, in this embodiment, at least one second user having view permission is determined in accordance with the level information and the associated user information, so as to open the corresponding target information to the second user and spare the second user from contacting the first user one by one to send the corresponding target information.

Wherein the associated user information contains an associated user identifier, which for example includes name or user account of the associated user. The corresponding second user is determined based on the associated user identifier.

In one embodiment of the present disclosure, after the level information of the first user is obtained, standard level information with view permission corresponding to the level information of the first user may be obtained, and the user matching the standard level information in the corresponding work group is obtained as the second user, wherein the standard level information includes, but not limited to, the first user himself, all upper-levels of the first user, other users having aligned permission to the first user (other users preconfigured with a permission to synchronize with the first user, generally being co-worker users at the same level with the first user), and the lower-level users directly under the first user. The standard level information may be set by the user himself or by default.

To satisfy individualized needs of the first user, the first user may set up the second user having view permission before releasing the target information. As shown in FIG. 5, a personnel structure list of the work group to which the user belongs may be displayed. Name tag of each work staff is displayed in the personnel structure list according to their level. When the first user hovers a select tool over a corresponding name tag (e.g., hovering a mouse control), the permission information of the corresponding user may be illustrated in a pop-up window or bubble. The permission information may include default permission of the corresponding user, i.e., whether the view permission to the work files sent by the first user is granted by default, and the first user may achieve individualized setting by modifying the view permission of the corresponding user.

Furthermore, in response to receiving from the second user a request for accessing the first page view of the first user, the first page view is displayed if it is determined that the identity of the second user is the above identity with view permission. The second user with view permission corresponding to different target information may vary. For example, if the first user who creates the target information changes, the corresponding second user with view permission may possibly be different. As such, when the first page view is displayed to the second user, the target information to which the second user has no view permission is hidden, and only the target information to which the second user has view permission is displayed.

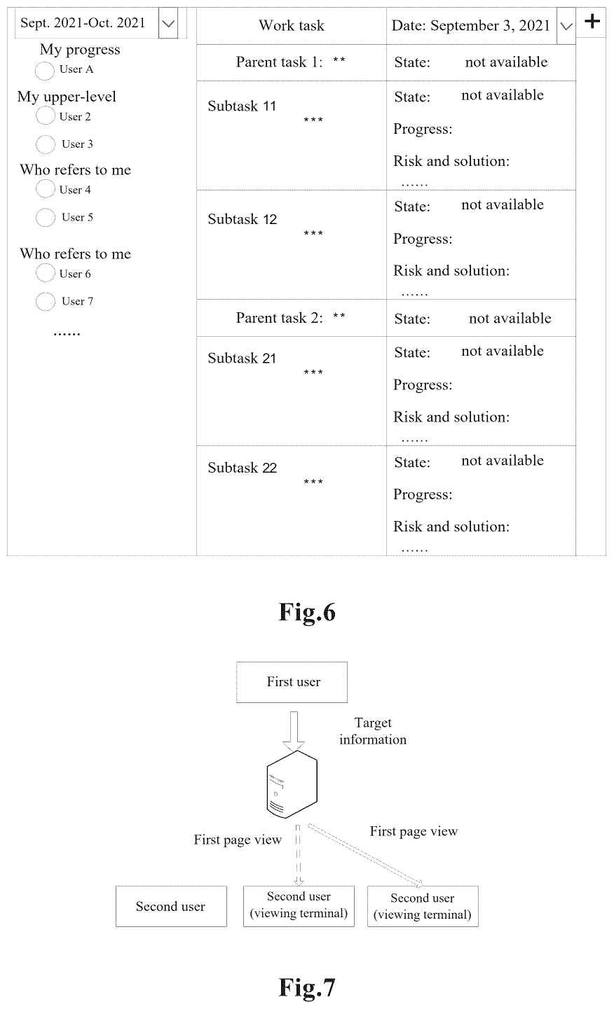

In actual execution, the way for obtaining the access request from the second user differs depending on the scenarios. For example, according to FIG. 6, the list of first users having view permission in the task group to which the second user A belongs may be displayed in a corresponding menu bar interface, wherein the first users are displayed by groups in accordance with the level information of the list of the first users. For instance, a grouping result contains the second user A himself, the first user (as the upper-level user of the second user), user aligned with first user, and the first user for which A is set as the associated user etc.

By triggering any one tag of the first user, A may obtain the access request from the second user. The first page view containing the target information released by the first user and to which A has view permission is displayed to the second user.

For example, a link of the first page view to which the second user has view permission may be displayed to the second user in the form of session messages. By triggering the corresponding link, the second user may obtain the access request from the second user. The first page view containing the target information released by the first user and to which A has view permission is then displayed to the second user.

For instance, each target information is associated with a corresponding item identifier, and the second user may trigger a corresponding search result by inputting the item identifier to which he/she has view permission through a preset search entry. That is, the access request from the second user is obtained. The first page view containing the target information released by the first user and corresponding to the item identifier is displayed to the second user.

In one embodiment of the present disclosure, when any user in the second user is detected, the first page view is controlled to be displayed on a corresponding viewing terminal after a viewing operation is performed on the target information released by the first user. As shown in FIG. 7, there may be multiple viewing terminals and the corresponding first page view may be viewed simultaneously on the multiple viewing terminals. Therefore, there is no need for sending the request for obtaining the corresponding target information to the first users separately, and the docking efficiency of the work progress report is further boosted.

Moreover, to meet the interaction needs of some users in the work group and further boost working efficiency, the viewing user also may post comments on the contents in the first page view, e.g., target description information and the like, and communicate the work based on the comments.

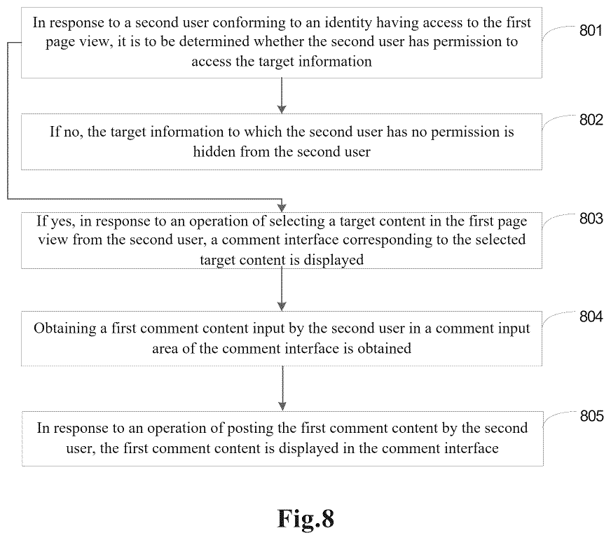

In one embodiment of the present disclosure, as shown in FIG. 8, the method also includes:

Step 801: in response to a second user conforming to an identity having access to the first page view, it is to be determined whether the second user has permission to access the target information;

Step 802: if no, the target information to which the second user has no permission is hidden from the second user.

In this embodiment, access permission is further configured besides the view permission, to facilitate fine management over the target information, wherein identity information of the second user having access permission also may be configured in the same way as the above second user having view permission. The details will not be elaborated here.

In this embodiment, the target information for which the user has no access permission will be hidden.

Step 803: if yes, in response to an operation of selecting a target content in the first page view from the second user, a comment interface corresponding to the selected target content is displayed.

That is, in this embodiment, if the second user has view permission to the first page view, a comment interface corresponding to the selected target content is displayed in response to an operation of selecting a target content in the first page view from a second user. The comment interface may be displayed in a pop-up window, i.e., aligned with the display size of the first page view and the pop-up window displays the corresponding comment interface.

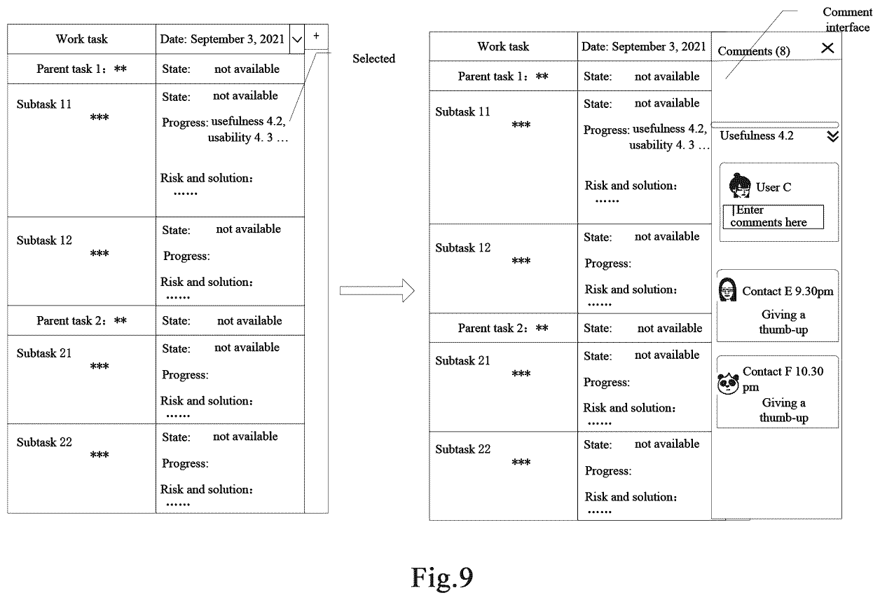

For example, as shown in FIG. 9, when the second user C selects “usefulness 4.2” as the target text content, the comment interface is displayed in pop-up window at the right sidebar of the first page view. The comment interface includes a comment input area in which the second user himself may input comment contents and historical comments etc. The historical comments may consist of comments from other users on the target text content.

Step 804: a first comment content input by the second user in a comment input area of the comment interface is obtained; and

Step 805: in response to an operation of posting the first comment content by the second user, the first comment content is displayed in the comment interface.

In one embodiment of the present disclosure, if the second user inputs a first comment content in the comment input area of the comment interface and clicks “POST” control, an operation of posting the first comment content is obtained.

If the second user inputs the first comment content but does not post it (e.g., clicking “CANCEL” control on the comment interface) or clicks a blank area of the comment interface, it is considered that the corresponding second user cancels the post of the first comment content.

After receiving from the second user the operation of posting the first comment content, the first comment content is displayed in the comment interface, wherein the first comment content may be displayed in the comment interface and may also be viewed by other viewing users.

In the embodiments of the present disclosure, to further satisfy the interaction needs between the users, there also provided functions for commenting and re-editing the historical comment information. In this embodiment, in response to a request for modifying a third comment content displayed on the comment interface from the second user, the third comment content is in editable state and is further updated in accordance with the contents edited by the second user. Before the third comment is controlled in the editable state, identity information of the second user may also be obtained, the identity information of the second user is determined as preconfigured user with comment-editing permission, or the viewing user is determined as the user who posts the third comment content in accordance with the identity information of the second user.

In actual execution, the second user also may post comments on comment contents posted by other viewing users. For example, the second comment content input by the second user in the comment editing box is obtained. In response to an operation of posting the second comment content by the second user, the second comment content is displayed in an area associated with the target comment content of the comment interface. This accordingly allows the users of the task group to exchange work progress. The area associated with the target comment content may be the area below the target comment content and equidistantly close to the target comment content.

In summary, the method for processing a task according to embodiments of the present disclosure posts comments directed against the target content in the first page view, to implement fine interactive comments on work progress on the basis of text granularity, further improve flexibility of work progress communications and provide technical support for enhancing work efficiency.

To implement the above embodiments, the present disclosure also provides an apparatus for processing a task.

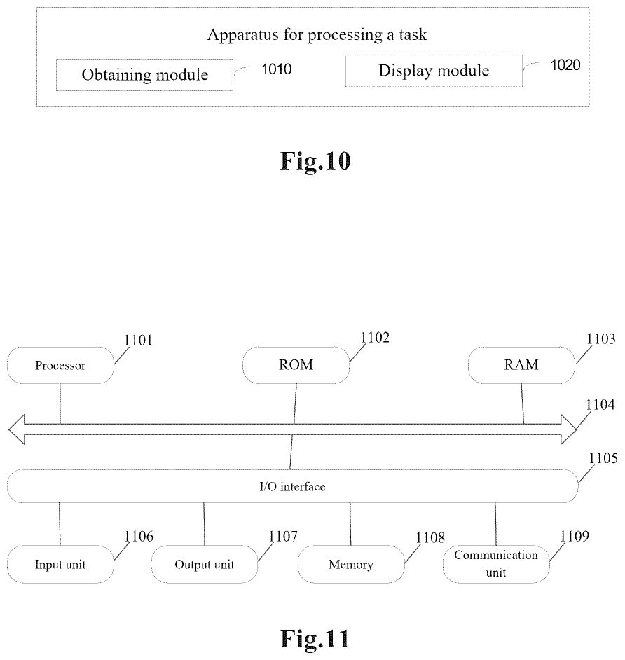

FIG. 10 is a structural diagram of the apparatus for processing a task provided by embodiments of the present disclosure. The apparatus may be implemented by software and/or hardware and is generally integrated in an electronic device. In FIG. 10, the apparatus comprises: an obtaining module 1010 and a display module 1020, wherein

An obtaining module 1010 for obtaining target information created by a first user; and

A display module 1020 for displaying, based on the target information, at least one of the target information in a first page view and displaying target description information corresponding to the at least one of the target information; wherein the target description information is created by a user having permission to target information.

The apparatus for processing a task provided by embodiments of the present disclosure may perform the method for processing a task provided by any embodiments of the present disclosure, include corresponding functional modules for executing the method and achieve the advantageous effects.

To implement the above embodiments, the present disclosure also proposes a computer program product, comprising a computer program/instructions, the computer program/instructions, when executed by the processor, implementing the method for processing a task in the above embodiments.

FIG. 11 illustrates a structural diagram of an electronic device provided by the embodiments of the present disclosure.

Specifically, with reference to FIG. 11, a structural diagram of an electronic device 1100 adapted to implement embodiments of the present disclosure is shown. In the embodiments of the present disclosure, the electronic device 1100 may include, but not limited to, mobile terminals, such as mobile phones, notebooks, digital broadcast receivers, PDAs (Personal Digital Assistant), PADs (tablet computer), PMPs (Portable Multimedia Player) and vehicle terminals (such as car navigation terminal) and fixed terminals, e.g., digital TVs and desktop computers etc. The electronic device shown in FIG. 11 is just an example and will not put any restrictions on the functions and application ranges of the embodiments of the present disclosure.

According to FIG. 11, the electronic device 1100 may include a processor (e.g., central processor, graphic processor and the like) 1101, which can execute various suitable actions and processing based on the programs stored in the read-only memory (ROM) 1102 or programs loaded in the random-access memory (RAM) 1103 from a storage unit 1108. The RAM 1103 can also store all kinds of programs and data required by the operations of the electronic device 1100. Processor 1101, ROM 1102 and RAM 1103 are connected to each other via a bus 1104. The input/output (I/O) interface 1105 is also connected to the bus 1104.

Usually, input unit 1106 (including touch screen, touchpad, keyboard, mouse, camera, microphone, accelerometer, gyroscope and like) and output unit 1107 (including liquid crystal display (LCD), speaker and vibrator etc.), storage unit 1108 (including tape and hard disk etc.) and communication unit 1109 may be connected to the I/O interface 1105. The communication unit 1109 may allow the electronic device 1100 to exchange data with other devices through wired or wireless communications. Although FIG. 11 illustrates the electronic device 1100 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including a computer program carried on a non-transitory computer readable medium, wherein the computer program include program codes for executing the method demonstrated by the flowchart. In these embodiments, the computer program may be loaded and installed from networks via the communication unit 1109, or installed from the storage unit 1108, or installed from the ROM 1102. The computer program, when executed by the processor 1101, performs the above functions defined in the method for processing a task according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

In some implementations, clients and servers may communicate with each other via any currently known or to be developed network protocols, such as HTTP (Hyper Text Transfer Protocol) and interconnect with digital data communications in any forms or media (such as communication networks). Examples of the communication networks include Local Area Network (LAN), Wide Area Network (WAN), internet of internet (e.g., Internet) and end-to-end network (such as ad hoc end-to-end network), and any currently known or to be developed networks.

The above computer readable medium may be included in the aforementioned electronic device or stand-alone without fitting into the electronic device.

The above computer readable medium bears one or more programs. When the above one or more programs are executed by the electronic device, the electronic device is enabled to: display, in the first view, corresponding target information and target description information corresponding to the target information after the first user creates the target information, wherein the target description information is created by a user having target permission. Thus, the relevant information of the task scatteringly reported by different users may be collectively viewed based on the related page view, which promotes the efficiency for viewing the task progress and provides technical support for review and summary of relevant work.

The electronic device may write computer program instructions for executing operations of the present disclosure in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be performed fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel essentially or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of special-purpose hardware and computer instructions.

Units described in the embodiments of the present disclosure may be implemented by software or hardware. In some cases, the name of the unit should not be considered as the restriction over the unit per se.

The functionality described herein can be performed, at least in part, by one or more hardware logic components. For example, and without limitation, exemplary types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable medium for example may include, but not limited to, electric, magnetic, optical, electromagnetic, infrared or semiconductor systems, apparatus or devices or any combinations thereof. More specific examples of the machine readable storage medium may include electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

The present disclosure proposes a method for processing a task, comprising steps of:

Obtaining target information created by a first user; and

Displaying, based on the target information, at least one of the target information in a first page view and displaying target description information corresponding to the at least one of the target information; wherein the target description information is created by a user having permission to target information.

In one embodiment of the present disclosure, the displaying at least one of the target information in a first page view and displaying target description information corresponding to the at least one of the target information includes:

Generating in the first page view a display frame including a first display area and at least one second display area, the first display area corresponding to at least one second display area and being used for displaying the target information, and the second display area being used for displaying the target description information.

In one embodiment of the present disclosure, the method also comprises:

Changing the display frame in response to an area editing request from a viewing user.

In one embodiment of the present disclosure, the changing the display frame in response to an area editing request from a viewing user includes:

In response to an area addition request for the display frame from the viewing user, obtaining an adding position corresponding to the area addition request; and

Adding a second display area at the adding position of the display frame in accordance with a preset display pattern of the second display area; and/or

In response to an area deletion request for the display frame from the viewing user, obtaining a first target display area corresponding to the area deletion request; and

Deleting the first target display area from the display frame; and/or,

In response to an area dragging request for the display frame from the viewing user, obtaining a second target display area corresponding to the area dragging request; and

Changing a display position of the second target display area in the display frame in accordance with the dragging request.

In one embodiment of the present disclosure, if the display frame is a list, the adding a second display area at the adding position of the display frame in accordance with a preset display pattern of the second display area comprises:

If the second display area is displayed in a column of the list, adding the second display area at the adding position in form of row in accordance with preset rendering parameters and default description information; or

If the second display area is displayed in a row of the list, adding the second display area at the adding position in form of column in accordance with preset rendering parameters and default description information.

In one embodiment of the present disclosure, the target information includes first target information and second target information, wherein each of the first target information corresponds to at least one second target information and the first target information is associated with the second target information in contents.

In one embodiment of the present disclosure, the first target information corresponds to at least one of state information; and the second target information corresponds to at least one of state information and at least one of the target description information.

In one embodiment of the present disclosure, the method further comprises:

In response to receiving a request for accessing a first page view of the first user from a second user, determining whether an identity of the second user belongs to at least one of: the first user, an upper-level user of first user, a lower-level user of first user, a user to which other target information aligned with the target information belongs, and a user mentioned in the target information; and

If yes, displaying the first page view.

In one embodiment of the present disclosure, the method further comprises: in response to a second user conforming to an identity having access to the first page view, determining whether the second user has permission to access the target information; and

If no, hiding the target information to which the second user has no permission from the second user.

In one embodiment of the present disclosure, the method comprises:

If yes, in response to an operation of selecting a target content in the first page view from the second user, displaying a comment interface corresponding to the selected target content;

Obtaining a first comment content input by the second user in a comment input area of the comment interface; and

In response to an operation of posting the first comment content by the second user, displaying the first comment content in the comment interface.

In one embodiment of the present disclosure, the method further comprises:

In response to a request for commenting a target comment content displayed on the comment interface from the second user, displaying a comment editing box;

Obtaining a second comment content input by the second user in the comment editing box; and

In response to an operation of posting the second comment content by the second user, displaying the second comment content in an area associated with the target comment content.

In one embodiment of the present disclosure, the obtaining target information created by a first user includes:

Obtaining target information created by the first user in a second page view.

In one embodiment of the present disclosure, the second page view and the first page view are different pages on the same client; or,

The second page view and the first page view are different pages on different clients.

Embodiments of the present disclosure provide an apparatus for processing a task, comprising:

An obtaining module for obtaining target information created by a first user; and

A display module for displaying, based on the target information, at least one of the target information in a first page view and displaying target description information corresponding to the at least one of the target information; wherein the target description information is created by a user having permission to target information.

In one embodiment of the present disclosure, the display module is configured for:

Generating in the first page view a display frame including a first display area and at least one second display area, the first display area corresponding to at least one second display area and being used for displaying the target information, and the second display area being used for displaying the target description information.

In one embodiment of the present disclosure, the apparatus also comprises a change module configured for: changing the display frame in response to an area editing request from a viewing user.

In one embodiment of the present disclosure, the change module is also configured for:

In response to an area addition request for the display frame from the viewing user, obtaining an adding position corresponding to the area addition request; and

Adding a second display area at the adding position of the display frame in accordance with a preset display pattern of the second display area; and/or,

In response to an area deletion request for the display frame from the viewing user, obtaining a first target display area corresponding to the area deletion request; and

Deleting the first target display area from the display frame; and/or,

In response to an area dragging request for the display frame from the viewing user, obtaining a second target display area corresponding to the area dragging request; and

Changing a display position of the second target display area in the display frame in accordance with the dragging request.

In one embodiment of the present disclosure, the change module is also configured for:

If the second display area is displayed in a column of the list, adding the second display area at the adding position in form of row in accordance with preset rendering parameters and default description information; or,

If the second display area is displayed in a row of the list, adding the second display area at the adding position in form of column in accordance with preset rendering parameters and default description information.

In one embodiment of the present disclosure, the target information includes first target information and second target information, wherein each of the first target information corresponds to at least one second target information and the first target information is associated with the second target information in contents.

In one embodiment of the present disclosure, the first target information corresponds to at least one of state information; and the second target information corresponds to at least one of state information and at least one of the target description information.

In one embodiment of the present disclosure, the display module is also configured for:

In response to receiving a request for accessing a first page view of the first user from a second user, determining whether an identity of the second user belongs to at least one of: the first user, an upper-level user of first user, a lower-level user of first user, a user to which other target information aligned with the target information belongs, and a user mentioned in the target information;

If yes, displaying the first page view.

In one embodiment of the present disclosure, the display module is also configured for: in response to a second user conforming to an identity having access to the first page view, determining whether the second user has permission to access the target information; and

If no, hiding the target information to which the second user has no permission from second user.

In one embodiment of the present disclosure, the display module is also configured for: if yes, in response to an operation of selecting a target content in the first page view from a second user, displaying a comment interface corresponding to the selected target content;

Obtaining a first comment content input by the second user in a comment input area of the comment interface; and

In response to an operation of posting the first comment content by the second user, displaying the first comment content in the comment interface.

In one embodiment of the present disclosure, the apparatus also comprises an editing module configured for:

In response to a request for commenting a target comment content displayed on the comment interface from the second user, displaying a comment editing box;

Obtaining a second comment content input by the second user in the comment editing box; and

In response to an operation of posting the second comment content by the second user, displaying the second comment content in an area associated with the target comment content.

In one embodiment of the present disclosure, the obtaining module is configured for:

Obtaining target information created by the first user in a second page view.

In one embodiment of the present disclosure, the second page view and the first page view are different pages on the same client; or,

The second page view and the first page view are different pages on different clients.

Embodiments of the present disclosure provide an electronic device, comprising:

A processor;

A memory for storing instructions executable by the processor;

Wherein the processor reads the executable instructions from the memory and performs the executable instructions to implement the above method for processing a task.

Embodiments of the present disclosure provide a computer-readable storage medium stored with a computer program, the computer program performing the above method for processing a task.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or concurrent processing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be implemented in multiple embodiments separately or in any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claim.

1. A method for processing a task, comprising:
obtaining target information created by a first user; and
displaying, based on the target information, at least one of the target information in a first page view and displaying target description information corresponding to the at least one of the target information; wherein the target description information is created by a user having permission to target information.

2. The method of claim 1, wherein displaying the at least one of the target information in the first page view and displaying the target description information corresponding to the at least one of the target information comprises:
generating in the first page view a display frame including a first display area and at least one second display area, the first display area corresponding to the at least one second display area and being used for displaying the target information, and the second display area being used for displaying the target description information.

3. The method of claim 2, further comprising:
changing the display frame in response to an area editing request from a viewing user.

4. The method of claim 3, wherein changing the display frame in response to the area editing request from the viewing user comprises:
in response to an area addition request for the display frame from the viewing user, obtaining an adding position corresponding to the area addition request; and
adding a second display area at the adding position of the display frame in accordance with a preset display pattern of the second display area; and/or
in response to an area deletion request for the display frame from the viewing user, obtaining a first target display area corresponding to the area deletion request; and
deleting the first target display area from the display frame; and/or,
in response to an area dragging request for the display frame from the viewing user, obtaining a second target display area corresponding to the area dragging request; and
changing a display position of the second target display area in the display frame in accordance with the dragging request.

5. The method of claim 4, wherein in a case where the display frame is a list, adding the second display area at the adding position of the display frame in accordance with the preset display pattern of the second display area comprises:
in a case where the second display area is displayed in a column of the list, adding the second display area at the adding position in form of row in accordance with preset rendering parameters and default description information; or,
in a case where the second display area is displayed in a row of the list, adding the second display area at the adding position in form of column in accordance with preset rendering parameters and default description information.

6. The method of claim 1, wherein the target information comprises first target information and second target information, wherein each of the first target information corresponds to at least one second target information and the first target information is associated with the second target information in contents.

7. The method of claim 6, wherein the first target information corresponds to at least one of state information; and the second target information corresponds to at least one of state information and at least one of the target description information.

8. The method of claim 1, further comprising:
in response to receiving a request for accessing the first page view of the first user from a second user, determining whether an identity of the second user belongs to at least one of: the first user, an upper-level user of first user, a lower-level user of first user, a user to which other target information aligned with the target information belongs, and a user mentioned in the target information; and
in a case where the identity of the second user belongs to at least one of: the first user, an upper-level user of first user, a lower-level user of first user, a user to which other target information aligned with the target information belongs, and a user mentioned in the target information, displaying the first page view.

9. The method of claim 1, further comprising:
in response to a second user conforming to an identity having access to the first page view, determining whether the second user has permission to access the target information; and
in a case where the second user does not have permission to access the target information, hiding the target information to which the second user has no permission from the second user.

10. The method of claim 8, further comprising:
in a case where the identity of the second user belongs to at least one of: the first user, an upper-level user of first user, a lower-level user of first user, a user to which other target information aligned with the target information belongs, and a user mentioned in the target information, in response to an operation of selecting a target content in the first page view from the second user, displaying a comment interface corresponding to the selected target content;
obtaining a first comment content input by the second user in a comment input area of the comment interface; and
in response to an operation of posting the first comment content by the second user, displaying the first comment content in the comment interface.

11. The method of claim 10, further comprising:
in response to a request for commenting a target comment content displayed on the comment interface from the second user, displaying a comment editing box;
obtaining a second comment content input by the second user in the comment editing box; and
in response to an operation of posting the second comment content by the second user, displaying the second comment content in an area associated with the target comment content.

12. The method of claim 1, wherein obtaining the target information created by the first user comprises:
obtaining the target information created by the first user in a second page view.

13. The method of claim 12, wherein the second page view and the first page view are different pages on the same client; or
the second page view and the first page view are different pages on different clients.

14. (canceled)

15. An electronic device, wherein the electronic device comprises:
a processor;
a memory for storing instructions executable by the processor;
wherein the processor reads the executable instructions from the memory and performs the executable instructions to:
obtain target information created by a first user; and
display, based on the target information, at least one of the target information in a first page view and display target description information corresponding to the at least one of the target information; wherein the target description information is created by a user having permission to target information.

16. A non-transitory computer-readable storage medium, wherein the computer-readable storage medium is stored with a computer program, and when executed by a computer processor, the computer program causes the computer processor to:
obtain target information created by a first user; and
display, based on the target information, at least one of the target information in a first page view and display target description information corresponding to the at least one of the target information; wherein the target description information is created by a user having permission to target information.

17. The electronic device of claim 15, wherein the processor performs the executable instructions further to:
generate in the first page view a display frame including a first display area and at least one second display area, the first display area corresponding to the at least one second display area and being used for displaying the target information, and the second display area being used for displaying the target description information.

18. The electronic device of claim 17, wherein the processor performs the executable instructions further to:
change the display frame in response to an area editing request from a viewing user.

19. The electronic device of claim 18, wherein the processor performs the executable instructions further to:
in response to an area addition request for the display frame from the viewing user, obtain an adding position corresponding to the area addition request; and
add a second display area at the adding position of the display frame in accordance with a preset display pattern of the second display area; and/or
in response to an area deletion request for the display frame from the viewing user, obtain a first target display area corresponding to the area deletion request; and
delete the first target display area from the display frame; and/or,
in response to an area dragging request for the display frame from the viewing user, obtain a second target display area corresponding to the area dragging request; and
change a display position of the second target display area in the display frame in accordance with the dragging request.

20. The electronic device of claim 19, wherein the processor performs the executable instructions further to:
in a case where the second display area is displayed in a column of the list, adding the second display area at the adding position in form of row in accordance with preset rendering parameters and default description information; or,
in a case where the second display area is displayed in a row of the list, adding the second display area at the adding position in form of column in accordance with preset rendering parameters and default description information.

21. The electronic device of claim 15, wherein the target information comprises first target information and second target information, wherein each of the first target information corresponds to at least one second target information and the first target information is associated with the second target information in contents.
